(19) United States
(12) Patent Application Publication
(10) Pub. No.: US 2016/0117717 A1
(43) Pub. Date: Apr. 28, 2016

(54) Systems and Techniques for Intelligent A/B Testing of Marketing Campaigns

(71) Applicant: Adobe Systems Incorporated, San Jose, CA (US)

(72) Inventors: Stéphane Moreau, L'Hay Les Roses (FR); Ashish Duggal, Delhi (IN); Sachin Soni, New Delhi (IN); Anmol Dhawan, Ghaziabad (IN)

(73) Assignee: Adobe Systems Incorporated

(21) Appl. No.: 14/525,760

(22) Filed: Oct. 28, 2014

(51) Int. Cl. G06Q 30/02; G06Q 50/00

(52) U.S. Cl. CPC G06Q 30/0243; G06Q 30/0245; G06Q 50/01

(57) ABSTRACT

Systems and methods for testing two or more pieces of marketing communication content that intelligently selects test recipients sets to get effective results in a timely manner. One embodiment involves identifying a category of a marketing campaign and identifying potential test recipients who are interested in the category based on interactions by each respective potential test recipient with prior marketing communications associated with the category. The embodiment further involves selecting a first subset and a second subset of the potential test recipients and sending the first marketing communication content to the first subset and sending the second marketing communication content to the second subset. The embodiment further involves assessing responsiveness of recipients of the first subset and assessing responsiveness of recipients of the second subset.

### TECHNICAL FIELD

This disclosure relates generally to computer-implemented methods and systems and more particularly relates to testing marketing campaign communications.

### BACKGROUND

Marketers often create several versions of a marketing communication, such as an email, and generally want to find out which version will have the biggest impact on a targeted population. A/B testing techniques have been used to test two variants of a marketing communication. For example, given two variants (A and B) and a target audience of 1000 people, the marketer may have sent 10 people variant A and another 10 people variant B. Based on those tests, the marketer identified which is better and sent the winning variant to the remaining 980 people.

The quality of the results of existing testing can depend upon the likes and interests of the particular recipients selected in the test samples. For example, if a campaign relates to music and 10 recipients are selected at random for the first variant who happen to have little interest in music and 10 recipients are selected at random for the second variant who have strong interests in music, the results of the testing may not accurately assess the merits of the different variants of the marketing communication.

The quality of existing testing can also depend on the typical response levels of the particular recipients selected in the test samples. For example, if each of the 10 recipients selected at random for the first variant happen to typically respond more frequently to marketing communications than the 10 recipients selected at random for the second variant, the results of the testing may not accurately assess the merits of the different variants of the marketing communication.

Additionally, existing A/B testing only compares the variants to one another and thus always selects a winner. However, pursuing the winning variant may not always be advisable, for example where the response to both variants is relatively low compared to typical or prior communications. By simply identifying a winning variant, existing techniques fail to identify circumstances in which the A/B testing includes information that could be used to suggest that neither variant is advisable, i.e., that the marketer should look for other alternatives.

Finally, existing A/B testing techniques must allow a significant amount of time (for example, 5 days) to wait for responses from the test recipients. However, sometimes a marketer desires to receive results in a shorter time frame. Existing A/B testing techniques do not adequately address shorter test durations or other time constraints.

Improved techniques for testing and sending marketing communications are desired.

### SUMMARY

According to certain embodiments, systems and methods are provided for testing two or more pieces of marketing communication content. One embodiment involves identifying a category of a marketing campaign. A first marketing communication content and a second marketing communication content relate to the category. The embodiment further involves identifying potential test recipients who are interested in the category based on interactions by each respective potential test recipient with prior marketing communications associated with the category. The potential test recipients are identified from a set of potential recipients. The embodiment further involves sending the first marketing communication content to a first subset of the potential test recipients and sending the second marketing communication content to a second subset of the potential test recipients. The embodiment further involves assessing responsiveness of recipients of the first subset and assessing responsiveness of recipients of the second subset.

Another exemplary embodiment involves identifying potential test recipients who are quick responders based on timing of interactions by each respective potential test recipient with prior marketing communications, the potential test recipients identified from a set of potential recipients. The embodiment involves sending the first marketing communication content to a first subset of the potential test recipients and sending a second marketing communication content to the second subset of the potential test recipients. The embodiment assesses responsiveness of recipients of the first subset and responsiveness of recipients of the second subset.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings.

FIG. 1 is a block diagram depicting an example of a system for managing recipient information, testing marketing campaign communications, and sending marketing communications.

FIG. 2 illustrates a user interface displaying exemplary recipient information stored in an exemplary requester information database.

FIG. 3 illustrates a graph showing a particular individual's responsiveness using several illustrative responsiveness attributes.

FIG. 4 illustrates a user interface displaying illustrative responsiveness attributes.

FIG. 5 illustrates additional examples of recipient responsiveness information in a table.

FIG. 6 illustrates an exemplary marketing campaign that may be analyzed by a service capable of inferring categories from content to identify one or more associated categories of the campaign.

FIG. 7 is a flow chart illustrating an exemplary method of performing targeted marketing communication testing based on a campaign category matching test recipient interest.

FIG. 8 is a flow chart illustrating an exemplary method of performing targeted marketing communication testing based on quickness of test recipient responses.

FIG. 9 is a block diagram illustrating exemplary computing components supporting the exemplary system of FIG. 1.

### DETAILED DESCRIPTION

Computer-implemented systems and methods are disclosed for testing two or more pieces of marketing communication content. The techniques can intelligently select test recipients sets to get effective results in a timely manner.

In one embodiment, a marketer is able to send different versions of a marketing communication to only some intended recipients, then select the version with the highest success ratings, and send it to the rest of his intended recipients. In such testing, the targeted recipient population is divided into three groups: two test groups and the remaining population. A different version of the marketing communication is sent to each test group and the responsiveness of those in the test group is monitored. The version of content with the best results is sent to the population that was not used as a test group. For example, a marketer at a major retailer may have to send a “Fashion Apparel Sales” email starting this weekend to 1 million users. He wants to test two formats of the email, inviting people for this sale. For this, he can select 10% of users for A/B testing and, based on the test results, send the winning email to rest (90%) of the users. The test results can be based on a customer tracking feature that tracks test recipient responsiveness, for example, tracking whether each of the test recipients opens the test email, clicks on content within the email, etc. Reactivity levels, engagement levels, and any other measure or measures of responsiveness of a recipient can be used.

The test groups may be selected in a random or non-random manner. One embodiment attempts to improve the quality of the testing by selecting the test groups based on criteria. For examples, test recipients can be selected as those potential recipients known historically to like, interact with, respond to, or otherwise have an interest in the advertisement's particular category. Examples of categories are: fashion, sports, mobiles, automotive, education, food, health, real estate, etc. A campaign of a new smart phone can be categorized as a “mobile” campaign and a campaign of clothing/apparel can be categorized as a “fashion” campaign. In one example, a “Fashion Apparel Sale” email may be directed to test recipients who have demonstrated through prior interactions or otherwise an openness or receptiveness to campaigns featuring fashion apparel, i.e., those having an interest in such categories. Such targeted testing can be facilitated by determining the category of every campaign (e.g., fashion, mobile, sports, furniture . . . ) that a marketer initiates. This category can then be stored, along with the other information about the campaign, in an integrated recipient profile of the user.

Comparing the responsiveness of the test groups (e.g., those receiving email A to those receiving email B) can be direct or may use a standardizing or leveling technique. For example, average values for the particular recipients in the test groups can be used to understand how much the recipient's responsiveness to the test emails differs from the recipient's average responsiveness to prior emails specific to the same category or in general. Thus, for example, the test email responsiveness of recipients with test email A and email B may be compared with reference to the historical average responsiveness of those recipients. The historical averages that are used may be specific to the corresponding category of campaign. In one example, for each test group, a group responsiveness level (which in this example is a numeric value) can be standardized by subtracting the group's average responsiveness level to the current “email campaign” from the group's average responsiveness level to past communications in campaigns of the same category. The standardized group responsiveness level of each group can then be compared to determine a winner of the testing, i.e., to select which email content is expected to have the better responsiveness.

Historical responsiveness data can be used in additional ways. For example, such information may be used to provide a recommendation that both email A and email B should be rejected based on both having a responsiveness that is below a certain threshold. In one example, a system may automatically suggest to the marketer that both email A and email B are no better than average and thus that he should redesign the campaign communication content. Identifying that both emails are not satisfactory can be based on a comparison of engagement level in the A/B testing with respect to the average responsiveness with this category of campaign. If the responsiveness for both email A and email B is less than the average responsiveness of past campaigns of this category, the system may suggest (or require) that the marketer redesign the content.

The systems and techniques for A/B testing of marketing campaigns may also be used to avoid the multi-day (e.g., 5 day) wait period typically involved in A/B testing. Better A/B testing results may be achieved in a much shorter time frame that better suits the time constraints of the marketer. This can be facilitated, for example, by selecting test recipients who historically respond (if they are to respond at all) relatively quickly. Users can, for example, be selected based on their interest in the relevant campaign category (fashion, mobile, sports, furniture, etc.) and who generally are responsive with respect to this category of campaign within the given time frame.

As used herein, the phrase “responsiveness” refers to a description or measure of a recipient's interaction, engagement, reactivity, or other activity that is responsive to one or more communications. Responsiveness may be qualitative and involve descriptive attributes (e.g., interested, not interested, quick responder, slow responder, etc.). Responsiveness may additionally or alternatively be quantitative, for example, where a numerical responsiveness level is determined as a measure of responsiveness. Responsiveness information may represent a recipient's loyalty, reactivity to offers, mobile engagement, social engagement, overall engagement, the recipient's depth of interest (e.g., whether the recipient glanced, skimmed, read, or otherwise spent a particular amount of time on the content). With respect to email, responsiveness may represent or be based on how quickly the recipient opens the email, whether the email is opened or not, whether the recipient clicks on links within the email, how the recipient interacts with the opened email, when the recipient closes the email, when the user deletes the email, etc. With respect to a text message, responsiveness may represent or be based on how quickly the recipient accesses the text message, whether the recipient responds to the text message, how quickly the recipient responds to the text message, whether the recipient clicks on a link within the text message, etc. With respect to a social media communication, responsiveness may represent or be based on how quickly the recipient accesses the social media message, whether the recipient comments on, likes, shares, etc. the social media message, whether the recipient clicks on a link within the social media message, etc.

As used herein, the phrase “interested in a category” refers to an attribute of a recipient that can be assessed based on interactions with prior communications associated with the category. This can be determined in various ways using various criteria and/or thresholds. In one example, a recipient is determined to be interested in a category if the recipient has previously opened at least one email communication related to the category. In another example, a recipient is determined to be interested in a category if the recipient has previously opened more email communication related to that category than any other category. In another example, a recipient is determined to be interested in a category if the recipient has a responsiveness level with respect to communications associated with the category that exceeds a threshold value. In another example, the recipient's interest level in a category is quantified based on the recipient's responsiveness to communications associated with the category and the recipient is determined to be interested in the category if his interest level exceeds a threshold value. Any suitable criteria and/or thresholding technique can be used for determining whether a recipient is interested in a category or not.

As used herein, the phrase “category” refers to a topic or theme with which a marketing campaign and its communications are associated. Examples of categories include but are not limited to: Fashion, Sports, Mobiles, Automotive, Education, Food, Health, and Real Estate. For example, a campaign of a particular series of cell phone may be categorized as a “Mobile” campaign. A campaign of clothing/apparel may be categorized as a “Fashion” campaign.

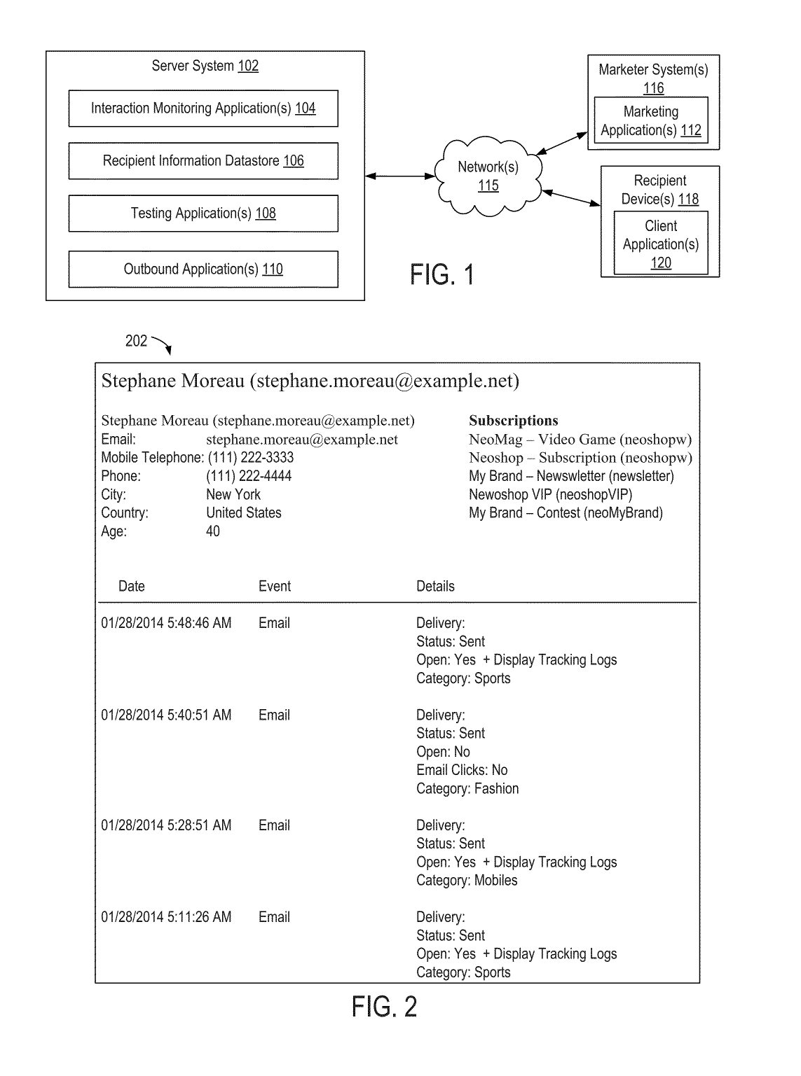

Referring now to the drawings, FIG. 1 is a block diagram depicting an example of a system for managing recipient information, testing marketing campaign communications, and sending marketing communications. The system includes a server system 102, marketer system(s) 116 and recipient device(s) 118 that interact with one another through network(s) 115. In this exemplary system, a marketer uses marketing system(s) 116 to initiate marketing communications for a marketing campaign using marketing application(s) 112. This may, for example, involve sending email advertisements to a group of recipients who access the email advertisements using client application(s) 120 at recipient device(s) 118.

The server system 102 includes features that facilitate the sending of such marketing communications, monitoring of interactions with such marketing communications, storing information about the recipients and the recipients' interactions with the communications, and testing of the marketing communications. These features, in alternative implementations, could be implemented on the marketer systems, on separate systems, or using any other computing environment that is appropriate for the particular circumstances and requirements being addressed.

In the example of FIG. 1, the server system 102 includes interaction monitoring application(s) 104 that monitor recipient responsiveness to marketing communications. This may be achieved using redirection techniques known to those in the art or other known or yet to be developed monitoring techniques. In one example, email marketing communications initiated by the marketer include links. Selection of the links by the recipient accesses server system 102 which tracks the interaction and redirects the recipient to the actual linked-to content, for example, provided on the marketer system(s) 116 or other content providing server. In this way (and using alternative or additional monitoring techniques), the interaction monitoring application(s) 104 monitor the responsiveness of recipients of marketing campaign communications.

Information about recipients of marketing communications can be stored in recipient information datastore 106. Such information can include, but is not limited to, identification information, personal information, address information, citizenship information, affiliation information, subscription information, responsiveness information, and any other appropriate type of information. Subscriber information may be organized within recipient information datastore 106 based on particular marketing entity. For example, two retail companies may each have their own accounts with a service provider that operates server system 102. Each retail company account may have recipient records. Thus, recipient information datastore 106 may include 100,000 recipient records for the first retail company and 3 million recipient records for the second retail company. Each of the retail companies, in this example, has access to its particular recipient account records.

FIG. 2 illustrates a user interface 202 displaying recipient information stored in recipient information datastore 106 in one exemplary embodiment. In this example, the user interface identifies the recipient's name, email address, mobile telephone number, phone number, city, country, age and subscription information. In addition, the user interface 202 displays information about the recipient's responsiveness to prior marketing communications. On Jan. 28, 2008 at 5:48:46 AM, the recipient received an email. The email was opened and related to the sports category. On Jan. 28, 2008 at 5:40:51 AM the recipient received an email. The email was not opened and related to the fashion category. On Jan. 28, 2008 at 5:28:51 AM, the recipient received an email. The email was opened and related to the mobiles category. On Jan. 28, 2008 at 5:11:26 AM, the recipient received an email. The email was opened and related to the sports category. In this example, the recipient information in the recipient information datastore 106 includes responsiveness information about specific marketing communications. The responsiveness information and information about the marketing communications described is merely illustrative. Alternative or additional information may be stored and/or presented via the user interface 202. Additionally or alternatively, summarized information may be stored and/or presented via the user interface 202. For example, information about the total number of emails, texts, and other marketing communications the recipient has received related to sports may be stored and/or displayed and information about the percentage of such communications that the recipient interacted with or any other score or measure of responsiveness may be stored in recipient information datastore 106 and/or presented in user interface 202.

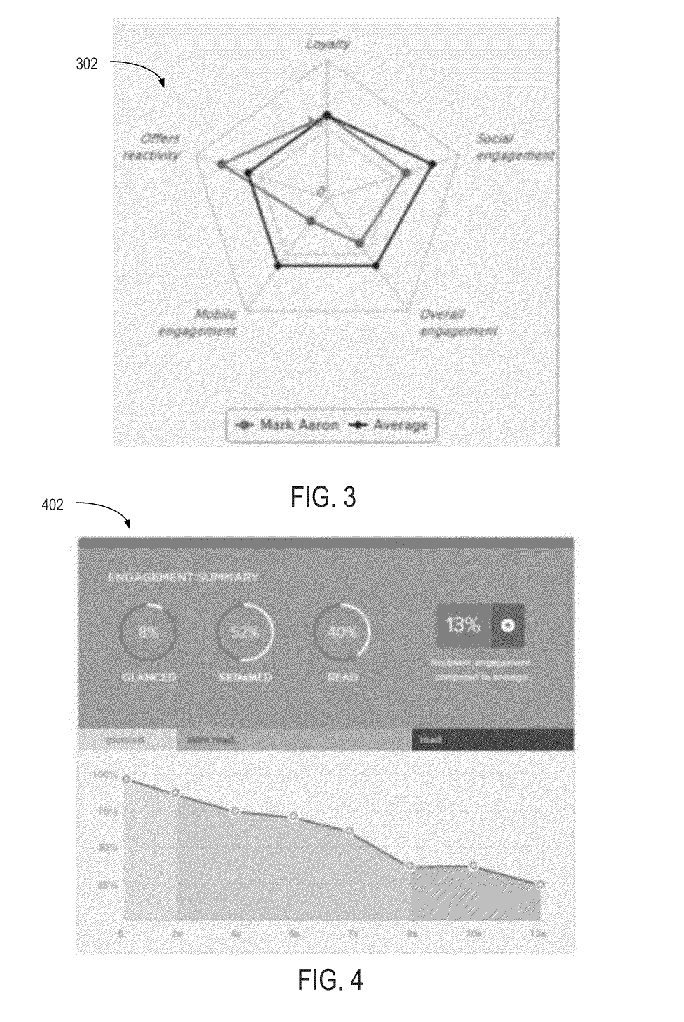

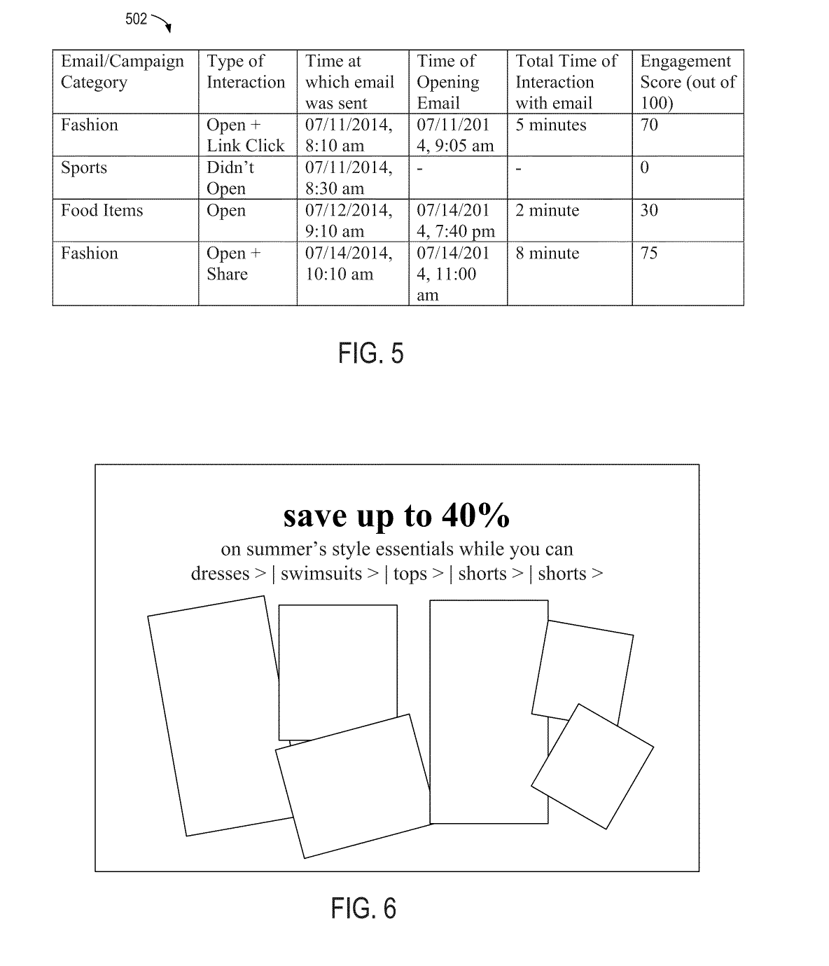

FIG. 3 illustrates a graph 302 showing how a particular individual's responsiveness in five responsiveness aspects (loyalty, offers reactivity, mobile engagement, social engagement, and overall engagement) compare with the average of recipient responsiveness in those aspects. FIG. 4 illustrates a user interface 402 displaying responsiveness aspects (glanced, skimmed, read) showing the percentage of engagement by a particular user with respect to each aspect, an overall recipient percentage of 13%, and a graph showing additional engagement details. FIG. 5 illustrates additional examples of recipient responsiveness information in a table 502. Recipient information datastore 106 (FIG. 1) can store responsiveness information such as that illustrated in FIGS. 3, 4, and 5 or about any suitable aspect of customer responsiveness. Recipient information datastore 106 may additionally compile and store average responsiveness information.

In FIG. 1, the server system 102 includes testing application(s) 108. Testing application(s) 108 can identify appropriate test recipients within a set of recipients. Such selection of test recipients can be based on various criteria to achieve various objectives. The testing application(s) 108 may identify for potential test recipients having an interest in one or more particular categories. The testing application(s) 108 may identify potential test recipients who are quick responders as determined based on timing of interactions by each respective potential test recipient with prior marketing communications, etc.

Testing application(s) 108 can provide a list of recipients to whom test marketing communications will be sent. Such test marketing communications can be sent via the marketing application 112 of the marketing system(s), through outbound application(s) 110 provided by the server system 102, through a combination, or through any other appropriate system. Such test marketing communications can be received by recipients using client application(s) 120 on recipient device(a) 118. As test recipients interact with or otherwise demonstrate responsiveness, communications between recipient device(s) 118 and interactive monitoring application 104 on the server system 102 monitor responsiveness and recipient information datastore 106 is updated to reflect such responsiveness. The testing application(a) 108 can then use the responsiveness information from the test recipients to provide information useful in determining marketing communications to send to additional recipients.

Testing application(s) 108 can facilitate A/B testing which intelligently selects recipients to get effective test results in a timely manner. For example, testing application(s) 108 may select recipient subsets for testing using a category that the marketer's campaign targets. For a sports campaign, the testing application(s) 108 may identify recipients who are interested in sports. The data used to identify recipients who are interested in sports may be developed from the recipients' prior interactions with marketing communications. Thus, as various campaign communications are sent to various recipients, the recipient information datastore 106 stores responsiveness information for those recipients that identifies categories of campaign communications involved. Users who have engaged more with sports emails than other emails may be determined to have demonstrated an interest in sports. Over time, the recipient information is built up to show a recipient's varying levels of interest in various categories of communications. An engagement score or responsiveness level (e.g., a score between 0 and 100) can be used to quantify recipient responsiveness and thus provide a quantitative measure of interest in each category. Recipients may thus be interested in multiple categories to varying degrees. Thresholds or similar techniques can be used to label a recipient as interested or not interested in a particular category, e.g., where a recipient is said to be interested in sports if her responsiveness level to sports campaign communications is greater than 50 out of 100. The system may also be able to determine that a given recipient is not interested in one or more particular category based on the recipient's prior lack of responsiveness to communications associated with those categories, e.g., where a recipient is said to be interested in sports if her responsiveness level to sports campaign communications is less than 50 out of 100.

In one example, a marketer wants to send a fashion related text communication to one thousand people and wants to select twenty people for A/B testing. The testing application(s) 108 selects all potential recipients who have average responsiveness levels of more than fifty for fashion related campaign communications. In this example, this results in eighty users. The testing application(s) 108 can then select twenty of those eighty users and perform the A/B testing of subsets of 10 recipients each. The testing application(s) 108 may select the twenty recipients randomly or may apply additional criteria. For example, the testing application(s) 108 may select the twenty recipients with the fastest average prior response times.

The computing architecture and environment illustrated in FIG. 1 is merely illustrative. The functions of this invention may be arranged in alternative ways. For example, the marketing system and server system applications may all be located on a marketer's computer devices or may all be hosted by a third party service separate from the marketer's computer devices. Similarly, additional entities and computing devices may be used to store and process data and otherwise provide the features and functions of this invention. In one embodiment, each of multiple marketing entities (e.g., retailers) has a discrete set of customer data that is hosted by a single, separate business entity and each company accesses its own recipient information for processing using its own testing and outbound marketing applications. In another embodiment, the business entity performing the marketing uses testing and outbound marketing applications hosted by yet other parties. In another embodiment, one or more marketing entities manage their own data center and use local or other party services for testing and outbound applications. The appropriate computing environment may depend on the marketing entity's size, sophistication, marketing requirements, and business relationships, among numerous other factors. In short, a variety of environments may be used to implement the features of this invention.

To support selection of test recipients, the server system 102 can identify the category of every campaign that a marketer initiates and store the category information with other information about the campaign in integrated customer profiles of the recipients in the recipient information datastore 106. FIG. 2 illustrates information from a sample recipient profile showing that the recipient opened and clicked on three emails out of the four emails sent to him. This information can be stored in integrated customer profiles of the recipients in the recipient information datastore 106 and can be based on a determination of which category (or categories) each email should be associated with. This integrated customer profile information can include information about interactions from both online and offline channels for a given recipient that is merged into the recipient's profile. For example, the server system 102 may track whether a recipient opens an email and clicks on particular portions of the email content and may record the time of every such interaction, and then store this information. For example, if the user opened the email or clicked a link in it, the category of the campaign will also be stored along with the corresponding responsiveness information. The responsiveness information may include a numeric score stored for every campaign communication in the recipient's profile. In one embodiment, such a score is calculated based upon two parameters: “Opening of email” and “Time Spent on the email.” In other embodiments, different parameter combinations may be used, for example, additionally or alternatively using “Link/Offer Click,” “Sharing of campaign,” etc.

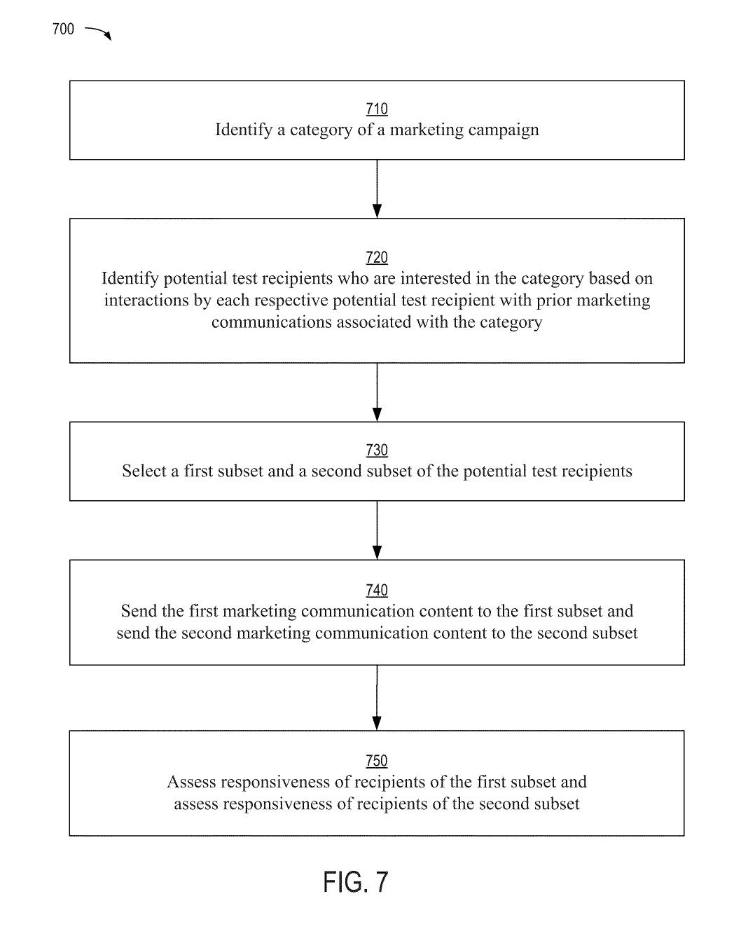

FIG. 7 is a flow chart illustrating an exemplary method 700 of performing targeted marketing communication testing based on communication category matching test recipient interest. The method 700 may be performed by one or more of the components illustrated in FIG. 1 (as noted in the description below) or by any other suitable component or in any other suitable computing and/or communication environments.

The method 700 involves identifying a category of a marketing campaign, as shown in block 710. This can be performed in a variety of ways. One exemplary embodiment involves the following exemplary features. For a new campaign initiated by a marketer, the system determines the category of the campaign ‘C’ by analyzing the campaign's content. This can be done by using, for example, Adobe SEDONA 3.0.5.3 offered by Adobe Systems. Inc. of San Jose, Calif., the Semantria API offered by Semantria USA Amherst, Mass., or by any other application or service capable of inferring categories from text or other content. The category of a marketing campaign can be inferred by analyzing the content of descriptive information about the campaign and/or one or more actual or potential marketing communications associated with the campaign.

FIG. 5 illustrates an exemplary marketing campaign communication. A service capable of inferring categories from content may analyze the marketing campaign communication of FIG. 5 and determine that the category of the campaign is fashion. The Semantria API could, for example, do so by mapping the content against Wikipedia taxonomies. In one example, identifying a category may involve identifying one of approximately 400 first-level auto-categories and one of 4000 or more second-level categories. Additionally or alternatively, user input may be used to identify or confirm the category or categories associated with a marketing campaign's communications. A marketer, for example, may be prompted to select a category from a predetermined list of categories. A category inferring service may return a “relevancy score,” which is a score between 0 and 1 that represents how confident it is about whether the content falls into that category. Such confidence information may be stored and used, for example, in weighting information about recipient responsiveness such that responsiveness to communications associated with categories with higher confidence are given more weight in determinations of recipient responsiveness to category-specific communications.

The method 700 further involves identifying potential test recipients who are interested in the category, as shown in block 720. This may involve determining potential test recipients who are interested in the category based on interactions by each respective potential recipient with prior marketing communications associated with the category.

When the marketer starts A/B testing for a new campaign, he may be presented with several test options in a user interface. For example, a marketer at a major retail chain needs to send a fashion apparel sales email starting this coming weekend to 1 million recipients. The marketer wants to test two formats of the email, inviting people for this sale. For this, he can select 10% of users for A/B testing and send the winning email to the rest (90%) of the users. The marketer will be given an option in a user interface to perform category-targeted A/B testing, for example, by selecting an option to perform “Smart User Set for A/B Testing.” The marketer will also able to specify the test duration by, for example, responding to a user interface option to choose the number of days in which the marketer wants a result. Based on this input, the server system 102 finds a set of recipients who are interested in the fashion category. In one embodiment, these recipients can be referred to as the “optimized set of users.”

The method 700 further involves selecting a first subset and a second subset of potential test recipients, as shown in block 730. In one embodiment, this involves simply dividing the recipients identified as having an interest in the category into two groups. However, it may also involve further strategic selection of recipients. For example, the server system 102 may only use recipients who are quick responders. For example, it may only use recipients who on average opened/interacted with past campaign communications of type ‘C’ within a particular time period, for example, within the same number of days as was specified as the test duration. While past A/B testing has required undesirable minimum waiting times, e.g., five days, to wait for test recipient responses, selecting quick responders as test recipients can allow the marketer to obtain results that are at least as accurate as those achieved using randomly identified test recipients but on a shorter time scale. Accordingly one embodiment involves a technique in which the marketer specifies the time in which to perform the A/B testing and then A/B testing is performed on those users who interact/react with the corresponding category in the time specified by the marketer.

The method 700 further involves sending a first marketing communication content to the first subset and sending a second marketing communication content to the second subset, as shown in block 740. The first and second marketing communications may be different versions of an email, for example, using different images, different sized fonts, different sale prices, etc.

The method 700 further involves assessing responsiveness of recipients of the first subset and assessing responsiveness of recipients of the second subset, as shown in block 750. Assessing responsiveness to the first and second marketing communication content can involve determining (a) a first responsiveness score for the first marketing communication content based on the responsiveness of the recipients of the first subset to the first marketing communication content and (b) a first average responsiveness of the recipients of the first subset to prior marketing communications related to the category. Similarly, determining a second responsiveness score for the second marketing communication content can be based on (a) the responsiveness of the recipients of the second subset to the second marketing communication content and (b) a second average responsiveness of the recipients of the second subset to prior marketing communications related to the category. For example, after sending group-specific emails to recipients in each of the test groups, the server system 102 may determine each group's responsiveness level to the group-specific email. The server system 102 then may find each group's average responsiveness level with past campaigns of type “C.” For each group, the system can use these values to determine the group's incremental gain/loss in responsiveness. Specifically, the server system 102 may determine an incremental gain/loss in responsiveness equal to the group's responsiveness level with this email minus the group's average responsiveness level for past campaigns of type “C.” The server system 102 may determine that the higher incremental gain is better for the marketer and select a winner based on incremental gain in responsiveness level being higher for one of the versions of the marketing communication than for the other version of the marketing communication. Accordingly, one embodiment involves determining the winner of A/B testing on the basis of the incremental gain/loss that ‘A’ and ‘B’ brings to responsiveness level for the corresponding category of campaign.

After assessing responsiveness of recipients of the first subset and assessing responsiveness of recipients of the second subset, winning content may be selected. Specifically, the first marketing communication content or the second marketing communication content can be selected as A/B test winning content based on comparing the responsiveness of the first subset and the responsiveness of the second subset. This may involve comparing numeric responsiveness scores. It alternatively may involve numeric responsiveness scores adjusted to represent incremental gain/loss as discussed above.

Once identified, the A/B test winning content can then be sent to additional recipients in the set of recipients. For example, if 10 percent of the recipients are used in the test, the winning content can be sent to the remaining 90 percent of the recipients. The server system 102 can then collect and store category-specific responsiveness information for the additional recipients based on the responsiveness of each of the additional recipients to the winning marketing communication. This information can thus supplement and continually update recipient category-specific responsiveness information that is stored and ultimately used in identifying future potential test recipients for future marketing communications.

If, for both groups, the server system 102 determines an incremental loss, it may determine that both versions of the marketing communication are performing below an expected level for this type of campaign and convey this to the marketer so that he can redesign and perform A/B testing again. Accordingly, one embodiment involves notifying a marketer in cases in which the responsiveness of both groups ‘A’ and ‘B’ in A/B testing are below their average responsiveness to past campaigns of this category. The server system 102 may identify an average responsiveness to prior marketing communications related to the category and provide a notification based on determining that the responsiveness of the recipients of the first subset and/or second subset is less than the average responsiveness.

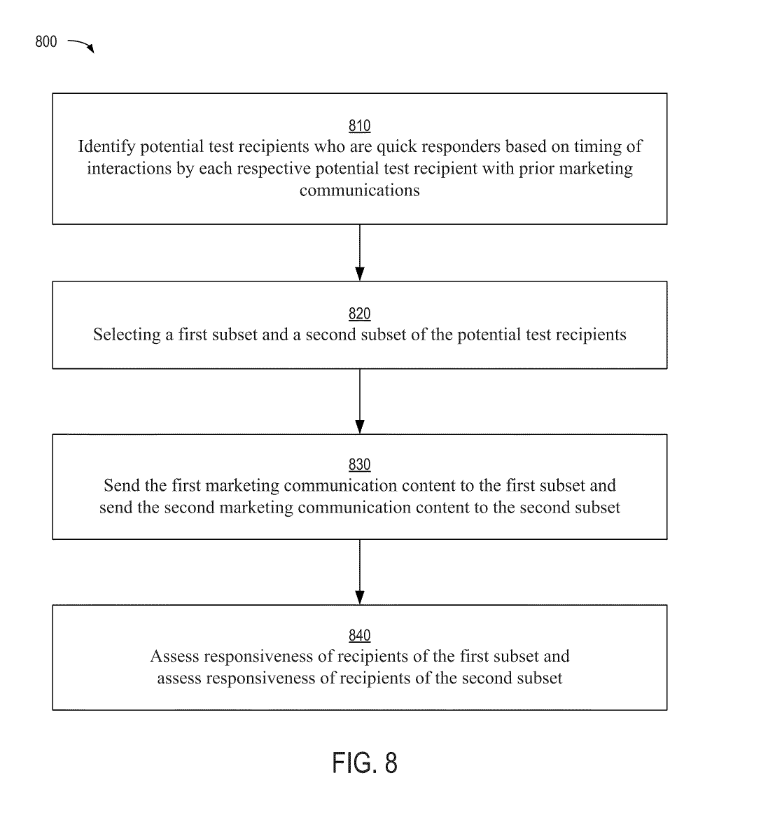

FIG. 8 is a flow chart illustrating an exemplary method 800 of performing targeted marketing communication testing based on quickness of test recipient responsiveness. Method 800 involves identifying potential test recipients who are quick responders, as shown in block 810. Quick responders can be identified as potential test recipients who have responded quickly (e.g., in specific instances or on average) to prior marketing communications. Identifying potential test recipients who are quick responders can involve identifying recipients whose average response time to the prior marketing communications is less than a threshold response time. The threshold response time may be determined based on input received from the user. For example, the user may request a test duration that is used as the threshold or to determine the threshold (e.g., the threshold may be selected to be 90% of the test duration, the threshold may selected to be 110% of the test duration, etc.). Identifying the potential test recipients who are quick responders may involve identifying test recipients who are both interested in the relevant marketing campaign category and whose average response time to the prior marketing communications is less than a threshold response time.

Method 800 further involves selecting a first subset and a second subset of the potential test recipients as shown in block 820. First marketing communication content is sent to the first subset and second marketing content is sent to the second subset, as shown in block 830. The method 800 then assesses the responsiveness of recipients of the first subset and responsiveness of recipients of the second subset, as shown in block 840. A winner can be selected or the user notified that neither of the marketing communications is satisfactory.

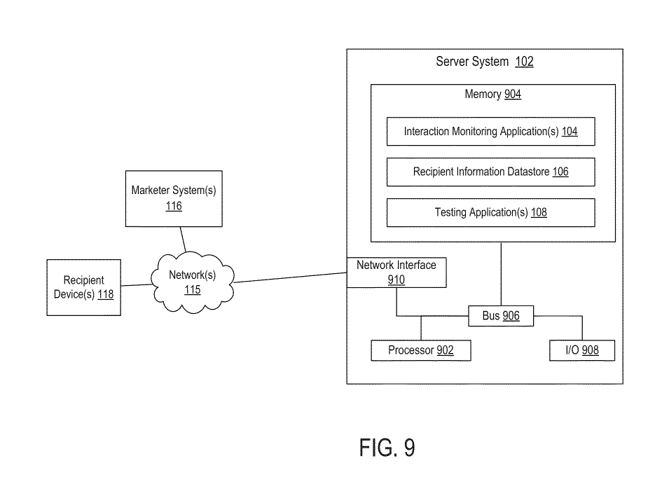

Any suitable computing system or group of computing systems can be used to implement the marketer system(s) 116, recipient device(s) 118, and server system 102. For example, FIG. 9 is a block diagram depicting examples of implementations of such components. The server system 102 can include a processor 902 that is communicatively coupled to a memory 904 and that executes computer-executable program code and/or accesses information stored in the memory 904. The processor 902 may comprise a microprocessor, an application-specific integrated circuit (“ASIC”), a state machine, or other processing device. The processor 902 can include one processing device or more than one processing device. Such a processor can include or may be in communication with a computer-readable medium storing instructions that, when executed by the processor 902, cause the processor to perform the operations described herein.

The memory 904 can include any suitable computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The server system 102 may also comprise a number of external or internal devices such as input or output devices. For example, the server system 102 is shown with an input/output (“I/O”) interface 908 that can receive input from input devices or provide output to output devices. A bus 906 can also be included in the server system 102. The bus 906 can communicatively couple one or more components of the server system 102.

The server system 102 can execute program code that configures the processor 902 to perform one or more of the operations described above. The program code can include one or more of the monitoring module 104 and the transaction application 106. The program code may be resident in the memory 904 or any suitable computer-readable medium and may be executed by the processor 902 or any other suitable processor. In some embodiments, modules can be resident in the memory 904, as depicted in FIG. 9. In additional or alternative embodiments, one or more modules can be resident in a memory that is accessible via a data network, such as a memory accessible to a cloud service.

The server system 102 can also include at least one network interface device 910. The network interface device 910 can include any device or group of devices suitable for establishing a wired or wireless data connection to one or more data networks 115. Non-limiting examples of the network interface device 910 include an Ethernet network adapter, a modem, and/or the like. The server system 102 can transmit messages as electronic or optical signals via the network interface device 910.

The marketing system(s) 116 and recipient device(s) 118 can similarly each include a processor that is communicatively coupled to a memory and that executes computer-executable program code and/or accesses information stored in the memory and otherwise include similar computing components as described with respect to server system 102.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of“adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. A method comprising:
identifying a category of a marketing campaign, wherein a first marketing communication content and a second marketing communication content relate to the category;
identifying, by a processing device, potential test recipients who are interested in the category based on interactions by each respective potential test recipient with prior marketing communications associated with the category, the potential test recipients identified from a set of potential recipients;
sending the first marketing communication content to a first subset of the potential test recipients and sending the second marketing communication content to a second subset of the potential test recipients; and
assessing responsiveness of recipients of the first subset and assessing responsiveness of recipients of the second subset.

2. The method of claim 1 further comprising selecting the first marketing communication content or the second marketing communication content as A/B test winning content based on comparing the responsiveness of the first subset and the responsiveness of the second subset.

3. The method of claim 2 further comprising sending the A/B test winning content to additional recipients in the set of recipients.

4. The method of claim 1 further comprising:
sending a marketing communication comprising at least one of the first marketing communication content and the second marketing communication content to additional recipients in the set of recipients; and
storing category-specific responsiveness information for the additional recipients based on responsiveness of each of the additional recipients to the marketing communication, wherein the category-specific responsiveness information is used in identifying future potential test recipients for future marketing communications.

5. The method of claim 1 further comprising:
determining a first responsiveness score for the first marketing communication content based on:
the responsiveness of the recipients of the first subset to the first marketing communication content; and
a first average responsiveness of the recipients of the first subset to prior marketing communications related to the category;
determining a second responsiveness score for the second marketing communication content based on:
the responsiveness of the recipients of the second subset to the second marketing communication content; and
a second average responsiveness of the recipients of the second subset to prior marketing communications related to the category.

6. The method of claim 5 further comprising selecting a winning marketing communication based on the first responsiveness score and the second responsiveness score.

7. The method of claim 1 further comprising:
identifying an average responsiveness to prior marketing communications related to the category; and
providing a notification based on determining that the responsiveness of the recipients of the first subset is less than the average responsiveness.

8. The method of claim 1 further comprising:
identifying an average responsiveness to prior marketing communications related to the category; and
providing a notification based on determining that the responsiveness of the recipients of the first subset is less than the average responsiveness and that the responsiveness of the recipients of the second subset is less than the average responsiveness.

9. The method of claim 8 wherein the average responsiveness is an average of responsiveness by potential recipients interested in the category.

10. The method of claim 1 wherein selecting the first subset and the second subset is based at least in part on how quickly each of the potential test recipients interacted with marketing communications in the past.

11. The method of claim 1 wherein identifying the category of the marketing campaign comprises performing an automated process on text associated with the campaign to identify the category from a set of predefined categories.

12. The method of claim 1 wherein identifying the category of the marketing campaign comprises receiving input selecting a category from a set of predefined categories.

13. The method of claim 1 further comprising accessing a database to identify the interactions by each respective potential test recipient with prior marketing communications associated with the category, wherein the database is updated with category-specific responsiveness information following marketing communications.

14. The method of claim 1 wherein the first marketing communication content and second marketing communication content are sent via email or text message.

15. The method of claim 1 wherein the first marketing communication content and second marketing communication content are sent via social media or direct mail.

16. A method comprising:
identifying, by a processing device, potential test recipients who are quick responders based on timing of interactions by each respective potential test recipient with prior marketing communications, the potential test recipients identified from a set of potential recipients;
sending the first marketing communication content to a first subset of the potential test recipients and sending the second marketing communication content to a second subset of the potential test recipients; and
assessing responsiveness of recipients of the first subset and assessing responsiveness of recipients of the second subset.

17. The method of claim 16 wherein identifying potential test recipients who are quick responders comprises identifying recipients whose average response time to the prior marketing communications is less than a threshold response time.

18. The method of claim 17 further comprising determining the threshold response time based on input received from a user.

19. The method of claim 18 wherein identifying the potential test recipients who are quick responders comprises identifying test recipients who are both interested in a marketing campaign category and whose average response time to the prior marketing communications is less than a threshold response time.

20. A system comprising:
a processing device; and
a non-transitory computer-readable medium communicatively coupled to the processing device,
wherein the processing device is configured to execute instructions to perform operations comprising:
identifying a category of a marketing campaign, wherein a first marketing communication content and a second marketing communication content relate to the category;
identifying, by a processing device, potential test recipients who are interested in the category based on interactions by each respective potential test recipient with prior marketing communications associated with the category, the potential test recipients identified from a set of potential recipients;
sending the first marketing communication content to a first subset of the potential test recipients and sending the second marketing communication content to a second subset of the potential test recipients; and
assessing responsiveness of recipients of the first subset and assessing responsiveness of recipients of the second subset.
